(19) United States
(12) Patent Application Publication
(10) Pub. No.: US 2013/0329780 A1
(43) Pub. Date: Dec. 12, 2013

(54) INVERSE TRANSFORM METHOD FOR ULTRA-HIGH RESOLUTION VIDEO CODEC

(71) Applicants: Jang-Hyun Park, Seoul (KR); Seong-Hoon CHOI, Seoul (KR); Chang-Beom KIM, Seoul (KR); In-Su JANG, Seoul (KR); Seong-Soo LEE, Seoul (KR); Jong-Sik PARK, Goyang-si (KR); Woo-Jin NAM, Seoul (KR); Seung-Mok HAN, Seoul (KR)

(72) Inventors: Jang-Hyun Park, Seoul (KR); Seong-Hoon CHOI, Seoul (KR); Chang-Beom KIM, Seoul (KR); In-Su JANG, Seoul (KR); Seong-Soo LEE, Seoul (KR); Jong-Sik PARK, Goyang-si (KR); Woo-Jin NAM, Seoul (KR); Seung-Mok HAN, Seoul (KR)

(73) Assignee: ELECTRONICS AND TELECOMMUNICATIONS RESEARCH INSTITUTE, Daejeon (KR)

(21) Appl. No.: 13/524,264

(22) Filed: Jun. 15, 2012

(30) Foreign Application Priority Data
Jun. 8, 2012 (KR) 10-2012-0061669

(51) Int. Cl. H04N 7/30

(52) U.S. Cl. 375/240.2; 375/E07.226

(57) ABSTRACT

Disclosed herein is an inverse transform method for an ultra-high resolution video codec. In the inverse transform method for an ultra-high resolution video codec using a Forward Discrete Cosine Transform (FDCT) algorithm, one of a plurality of pixel values is input as a first pixel value. One of remaining pixel values other than the first pixel value is input as a second pixel value. A first median value is calculated using a butterfly operation by applying coefficient values, respectively corresponding to the first and second pixel values, to the first and second pixel values. The first pixel value is replaced with the calculated first median value so as to re-perform the inverse transform method.

### CROSS REFERENCE TO RELATED APPLICATION

This application claims the benefit of Korean Patent Application No. 10-2012-0061669, filed on Jun. 8, 2012, which is hereby incorporated by reference in its entirety into this application.

### BACKGROUND OF THE INVENTION

1. Technical Field

The present invention relates generally to an inverse transform method for an ultra-high resolution video codec and, more particularly, to an inverse transform method that configures an optimized operation unit to process inverse transform coding and reuses the optimized operation unit, thus minimizing the area of hardware.

2. Description of the Related Art

Currently, video compression codecs use 4×4 or 8×8 block size transform coding. By using this coding, the amount of multimedia information is compressed, so that a High-Definition Television (HDTV) for HD videos has been popularized. Accordingly, as users become accustomed to high-quality and high-resolution videos, full-HD level videos can be played even on mobile devices. Next-generation video devices have been gradually developed into schemes for supporting high quality, high resolution, and high reality, such as in full-HD three-dimensional (3D) videos, Ultra-High Definition (UHD) video devices, and bidirectional HD-level video calls between mobile devices, compared to conventional schemes.

A problem with such next-generation video services is that the amount of multimedia information increases in geometric progression compared to conventional video services. For example, in the case of 3D videos, the amount of data that is twice the amount of data in existing 2D videos is required, and in the case of Ultra-Definition (UD) videos, the amount of data that is four times the amount of data in existing full-HD videos is required. In the case of UHD videos, the considerable amount of data that is 16 times the amount of data in existing full-HD videos is required.

Therefore, in order to solve this problem, it has become recognized that transform coding using a larger block size is required so as to improve compression efficiency for high-quality and high-resolution videos.

Korean Unexamined Patent Application Publication No. 2011-0063856 discloses technology related to video coding based on a transform using a block size of greater than 4×4 and 8×8. However, the technology disclosed in the above patent is limited in that when inverse transform coding using a larger block size is designed by hardware, the area of the hardware increases.

Therefore, newer technology is urgently required so as to perform an inverse transform for an ultra-high resolution video codec.

### SUMMARY OF THE INVENTION

Accordingly, the present invention has been made keeping in mind the above problems occurring in the prior art, and an object of the present invention is to provide an operation unit that can be used in common even for 16×16 and 32×32 block sizes.

Another object of the present invention is to minimize the area of hardware by reusing an operation unit.

In accordance with an aspect of the present invention to accomplish the above object, there is provided an inverse transform method for an ultra-high resolution video codec using a Forward Discrete Cosine Transform (FDCT) algorithm, including inputting one of a plurality of pixel values as a first pixel value, inputting one of remaining pixel values other than the first pixel value as a second pixel value, calculating a first median value using a butterfly operation by applying coefficient values, respectively corresponding to the first and second pixel values, to the first and second pixel values, and replacing the first pixel value with the calculated first median value so as to re-perform the inverse transform method.

In this case, the inputting as the second pixel value may be configured to select the second pixel value using a 4:1 multiplexer.

In this case, the calculating the first median value may be configured to resolve each of the coefficient values into numbers corresponding to an nth power of 2, perform a shift operation on each of the first pixel value and the second pixel value a number of times corresponding to exponents of the nth power of 2, and perform addition or subtraction between shifted values of the first and second pixel values, thus calculating the first median value.

In this case, the plurality of pixel values are pixel values corresponding to a 16×16 block size.

In an embodiment, the inverse transform method may further include inputting one of remaining pixel values, other than the first pixel value and the second pixel value among the plurality of pixel values, as a third pixel value, inputting one of remaining pixel values, other than the first pixel value, the second pixel value, and the third pixel value, as a fourth pixel value, calculating a second median value using a butterfly operation by applying coefficient values, respectively corresponding to the third and fourth pixel values, to the third and fourth pixel values, replacing the second pixel value with the second median value so as to re-perform the inverse transform method, and calculating final values using a butterfly operation by applying coefficient values, respectively corresponding to the first and second median values, to the first and second median values.

In accordance with another aspect of the present invention to accomplish the above object, there is provided an inverse transform method for an ultra-high resolution video codec, the method inverse-transforming pixel values corresponding to a 32×32 block size using a Forward Discrete Cosine Transform (FDCT) algorithm, including dividing the pixel values into a first group and a second group, each having pixel values corresponding to a 16×16 block size, selectively inputting two of 16 pixel values of the first group and calculating 16 median values using a butterfly operation, and selectively inputting two of the 16 median values and calculating 16 final values using the butterfly operation.

In this case, the inverse transform method may further include selectively inputting two of 16 pixel values of the second group and calculating 16 median values using a butterfly operation, and selectively inputting two of the 16 median values and calculating 16 final values using the butterfly operation.

In this case, the inverse transform method may further include selectively inputting two of 32 final values calculated by the first and second groups, and calculating 32 finally transformed values using the butterfly operation.

In this case, the dividing into the first and second groups may be configured to divide the pixel values into odd-numbered pixel values and even-numbered pixel values.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing an inverse transform method for an ultra-high resolution video codec according to an embodiment of the present invention;

FIG. 2 is a flowchart showing an inverse transform method for an ultra-high resolution video codec according to an embodiment of the present invention;

FIG. 3 is a diagram showing inverse transform process elements for an ultra-high resolution video codec according to an embodiment of the present invention;

FIG. 4 is a diagram showing a typical butterfly operation structure;

FIG. 5 is a diagram showing a butterfly operation structure corresponding to a 32×32 block size according to an embodiment of the present invention;

FIG. 6 is a diagram showing a 32×32 block size butterfly operation structure to which a 4:1 multiplexer is applied according to an embodiment of the present invention;

FIG. 7 is a diagram showing the first stage of the inverse transform method for an ultra-high resolution video codec according to an embodiment of the present invention;

FIG. 8 is a diagram showing an inverse transform method for an ultra-high resolution video codec having a 16×16 block size according to an embodiment of the present invention;

FIG. 9 is a diagram showing the procedure of calculating a median value according to an embodiment of the present invention;

FIG. 10 is a diagram showing an inverse transform method for an ultra-high resolution video codec having a 32×32 block size according to an embodiment of the present invention;

FIG. 11 is a diagram showing an inverse transform method for an ultra-high resolution video codec having a 32×32 block size according to an embodiment of the present invention;

FIG. 12 is a diagram showing median values input for respective operation stages of a 32×32 block size according to an embodiment of the present invention; and

FIG. 13 is a diagram showing coefficient values and formulas applied to calculate median values according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, embodiments of the present invention will be described in detail with reference to the attached drawings.

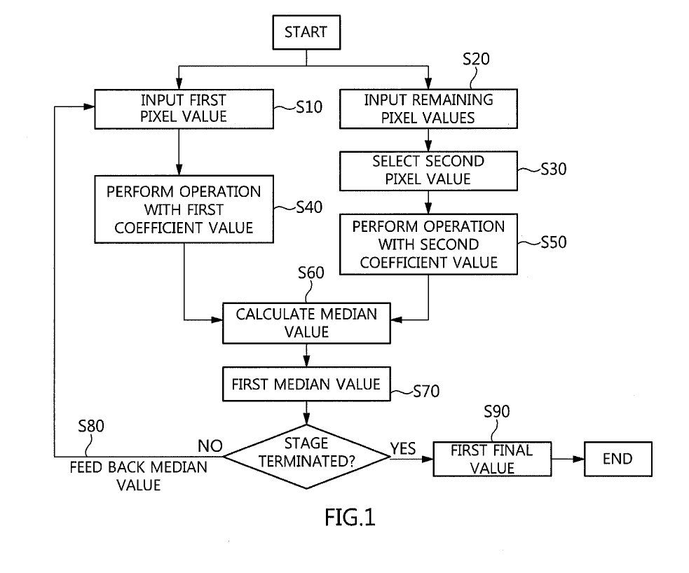

FIG. 1 is a flowchart showing an inverse transform method for an ultra-high resolution video codec according to an embodiment of the present invention.

The inverse transform method for an ultra-high resolution video codec is based on an inverse Forward Discrete Cosine Transform (FDCT) algorithm of Chen.

The inverse transform method for the ultra-high resolution video codec according to the embodiment of the present invention derives finally inverse-transformed values in a video compression codec having 16 or 32 pixel values corresponding to a 16×16 or 32×32 block size.

In the inverse transform method for the ultra-high resolution video codec according to the embodiment of the present invention, one of a plurality of pixel values is input at step S10.

Hereinafter, the pixel value input at step S10 is called a ‘first pixel value.’

Thereafter, the remaining pixel values other than the first pixel value among the plurality of pixel values are input at step S20.

In this case, in the case of a 16×16 block size, 15 pixel values are input, and in the case of a 32×32 block size, 31 pixel values are input.

Meanwhile, in the case of the 32×32 block size, the pixel values are divided into two parts, that is, odd-numbered pixel values and even-numbered pixel values, and then transform can be performed on each of the parts having pixel values corresponding to a 16×16 block size.

Thereafter, any one pixel value is selected from among the remaining pixel values, input at step S20, at step S30.

Hereinafter, the pixel value input at step S30 is called a ‘second pixel value.’

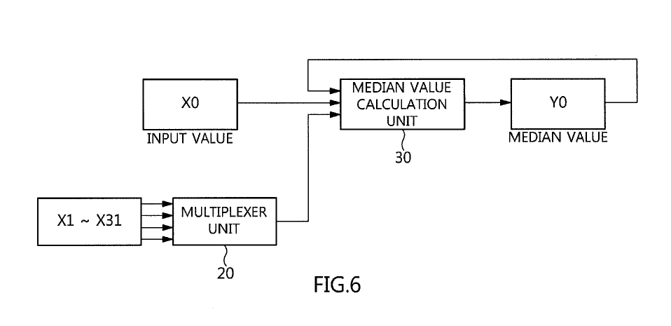

In this case, the procedure for selecting the second pixel value can be implemented using a 4:1 multiplexer, and this will be described in detail later with reference to FIG. 6.

Coefficient values respectively corresponding to the first and second pixel values are applied to the first and second pixel values through an FDCT algorithm, and operations are performed at steps S40 and S50. A median value is derived by performing addition or subtraction between the operated values at steps S60 and S70.

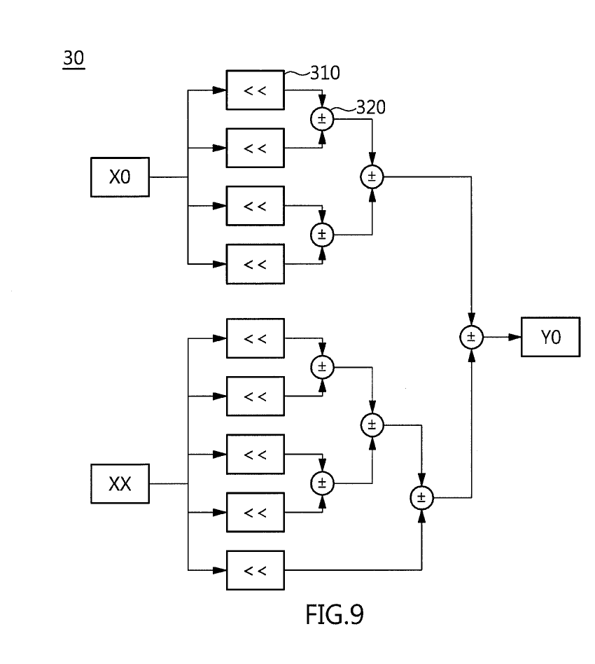

In this case, the procedure of applying the coefficient values to the first and second pixel values and deriving the median value can be performed by replacing a multiplication operator with a shift operator, an addition operator and a subtraction operator. This replacement will be described in detail later with reference to FIG. 9.

Thereafter, it is determined whether operations corresponding to six stages in the case of the 16×16 block size or operations corresponding to eight stages in the case of the 32×32 block size have been completed.

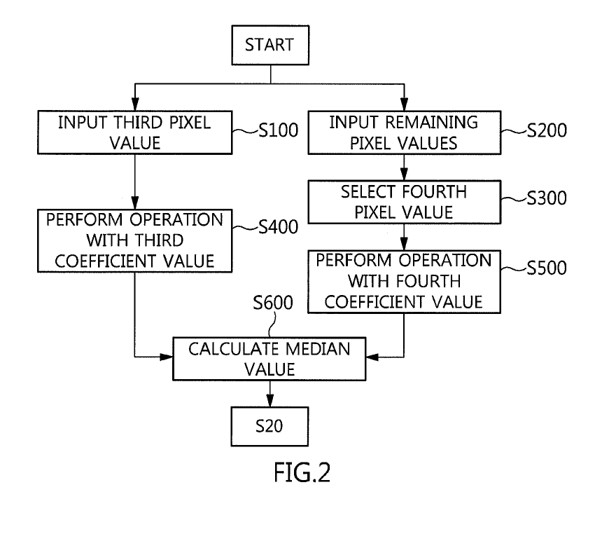

If inverse transform stages required by respective block sizes have not yet been completed, the first median value is fed back to the place of the first pixel value input at step S10 at step S80. A second median value, which will be described later with reference to FIG. 2, is fed back to step S20, and then the process ranging from step S10 to step S70 is repeatedly performed.

In contrast, if all the stages have been completed, the corresponding median value is derived as a first final value at step S90.

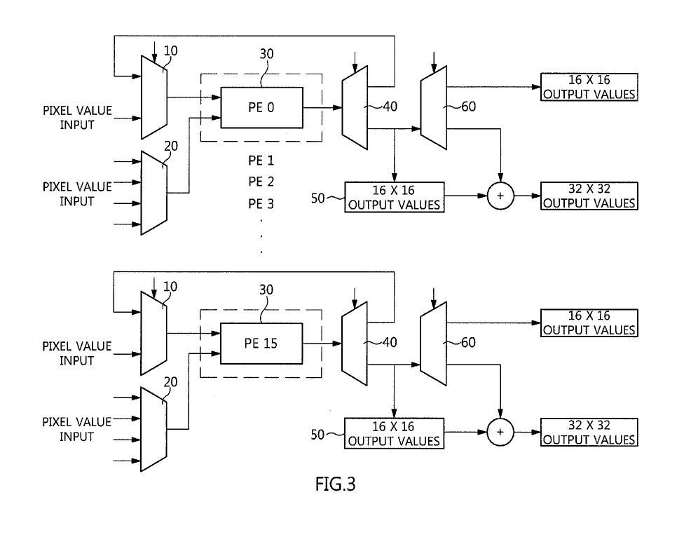

The inverse transform method of FIG. 1 is performed by inverse transform process elements for the ultra-high resolution video codec according to an embodiment of the present invention. The inverse transform process elements will be described later with reference to FIG. 3.

FIG. 2 is a flowchart showing an inverse transform method for an ultra-high resolution video codec according to an embodiment of the present invention.

Steps S100 to S600 of FIG. 2 are identical to steps S10 to S60 of FIG. 1, and thus a detailed description thereof will be omitted.

A second median value derived by the method of FIG. 2 is fed back to the place of the second pixel value and then the corresponding stage is performed, similarly to the description of FIG. 1.

FIG. 3 is a diagram showing inverse transform process elements for an ultra-high resolution video codec according to an embodiment of the present invention.

Referring to FIG. 3, the inverse transform process elements for the ultra-high resolution video codec according to the embodiment of the present invention include first and second multiplexers 10 and 20, first and second demultiplexers 40 and 60, and median value calculation units 30.

The inverse transform process elements for the ultra-high resolution video codec according to the embodiment of the present invention derive finally inverse-transformed values using 16 or 32 pixel values corresponding to a 16×16 or 32×32 block size in a video compression codec.

Each first multiplexer 10 inputs any one of a plurality of pixel values corresponding to the 16×16 or 32×32 block size.

Each second multiplexer 20 inputs the remaining pixel values other than the pixel value, which has been input to the first multiplexer 10, among the plurality of pixel values.

In this case, each multiplexer denotes a combination circuit for selecting one of a plurality of inputs and connecting the selected input as a single output. A 4:1 multiplexer can be used as the second multiplexer 20 according to an embodiment of the present invention.

The principle of use of the 4:1 multiplexer will be described later with reference to FIG. 6.

One of the pixel values input through the second multiplexer 20, together with the pixel value input through the first multiplexer 10, are input to the median value calculation unit 30.

From the pixel values input to the median value calculation unit 30, a median value thereof is derived and then output. The median value is input to the first demultiplexer 40 and is then fed back to the place of the first multiplexer 10.

The median value calculation unit 30 performs an operation procedure using coefficient values corresponding to the respective pixel values that have been input through the first multiplexer 10 and the second multiplexer 20. The median value is derived according to this operation procedure.

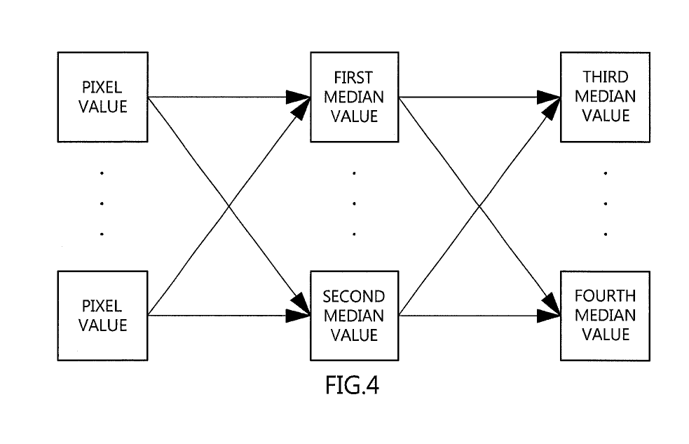

A shift operation and an addition or subtraction operation are applied to the procedure of deriving the median value using the coefficient values. This procedure will be described later with reference to FIGS. 4 to 6.

An inverse transform process unit for an ultra-high resolution video codec according to an embodiment of the present invention is a unit for deriving a single median value from two pixel values, and a total of 16 process elements are required so as to derive 16 final values from 16 pixel values.

In this case, the total of 16 process elements may be combined into a single process unit.

Meanwhile, in the procedure of processing an inverse transform using 16 or 32 pixel values corresponding to the 16×16 or 32×32 block size, if the procedure of inputting pixel values to a single process unit and recursively applying and operating a median value derived depending on the input pixel values is repeatedly performed for six stages in the case of the 16×16 block size, final values are derived.

That is, the median value derived in the first stage is fed back and is then used as an input of the second stage by the same process unit, and a new median value is derived via the same procedure. This procedure is repeated for six stages. Accordingly, in the conventional technology, a total of six process units were required so as to process the six stages of the inverse transform procedure, but in the present invention, an operation procedure corresponding to eight stages can be processed using only a single process unit through a feedback procedure, thus remarkably reducing the size of hardware.

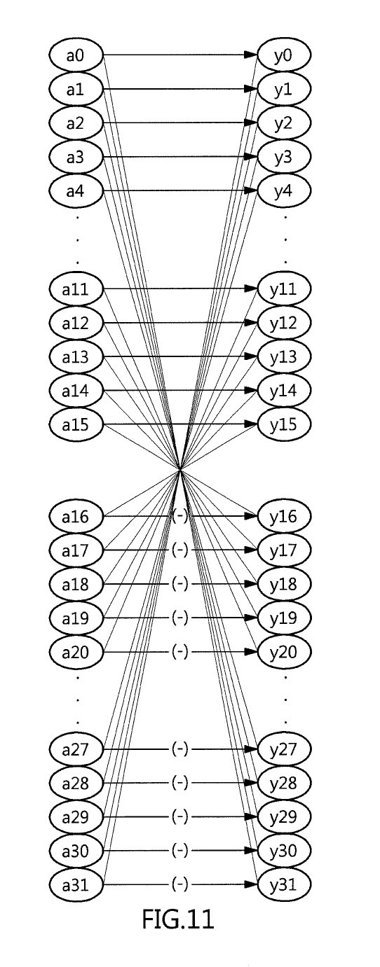

In the case of the 32×32 block size, pixels values are divided into two groups, each having pixel values corresponding to a 16×16 block size. Thereafter, seven stages of operations are performed on each 16×16 group by a single process unit, and then consequently derived final values are stored in the output value storage unit 50. As shown in FIG. 11, a median value operation is performed on a total of 32 final values derived from the two groups, and then finally inverse-transformed values can be derived.

That is, the procedure of inverse-transforming 32×32 block size pixel values can be processed using a single process unit for processing the 16×16 block size, so that there is no need to separately design hardware for processing an inverse transform on 16×16 and 32×32 block sizes.

In the case of the 32×32 block size, the method of dividing pixel values into two groups of the 16×16 block size can be implemented as a method of dividing the pixel values into odd-numbered pixel values and even-numbered pixel values.

FIG. 4 is a diagram showing a typical butterfly operation structure.

Referring to FIG. 4, in order to obtain a single median value, two input values are required. One input is a pixel value present on the same line as that of a previous stage. The other input is one of the remaining inputs other than the pixel value present on the same line as that of the previous stage.

A value calculated using these two inputs becomes one of the input values required by a subsequent stage. The other input value is one of the remaining median values other than the median value on the same line, similarly to the above procedure. That is, the butterfly operation structure uses a repetitive scheme for receiving two input values in each stage and calculating a median value and transfers it to a subsequent stage as input.

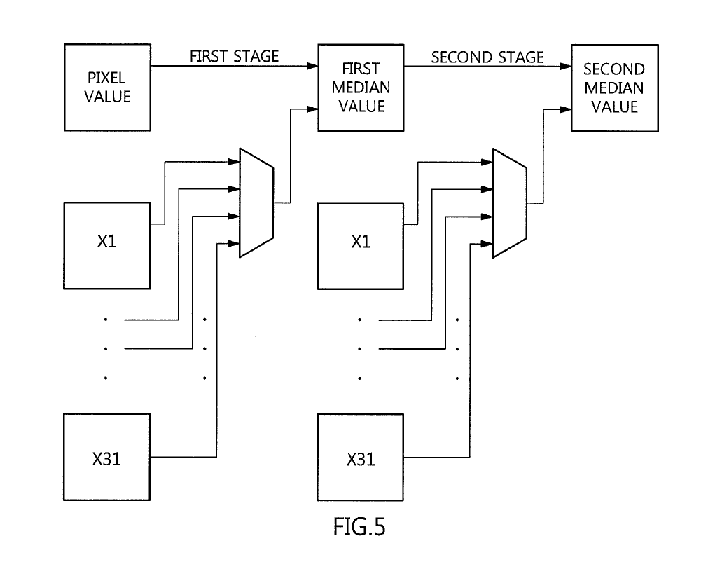

FIG. 5 is a diagram showing the butterfly operation structure corresponding to a 32×32 block size according to an embodiment of the present invention.

Referring to FIG. 5, it can be seen that among 32 inputs, one pixel value on the same line is used as one input, and one of the remaining 31 pixel values is used as the other input.

A pixel value X0 is used as one input value, and the remaining 31 pixel values other than the pixel value X0 among the 32 pixel values are input to a multiplexer, so that one of the 31 pixel values is selected to perform a first stage operation, and a first median value is derived from the first stage operation.

Thereafter, in a second stage, similarly to the above first stage, the first median value becomes one input value, and a second median value is derived from a second median value operation performed between the first median value and one pixel value selected from among the remaining 31 pixel values.

FIG. 6 is a diagram showing a 32×32 block size butterfly operation structure to which a 4:1 multiplexer is applied according to an embodiment of the present invention.

Referring to FIG. 6, it can be seen that the structure of the multiplexer for processing pixel values X1 to X31 in the 32×32 block size butterfly operation structure of FIG. 5 is replaced with a 4:1 multiplexer 20.

Since 31 pixel values must be processed when process elements are implemented using the characteristics of the butterfly operation structure, a problem may arise in that the size of the multiplexer increases. That is, as one of two input values is selected from among 31 median values, a 31:1 structure is required. Further, as the process unit is configured using 16 process elements, a problem arises in that 16 31:1 multiplexers are used, and thus the area of the hardware increases.

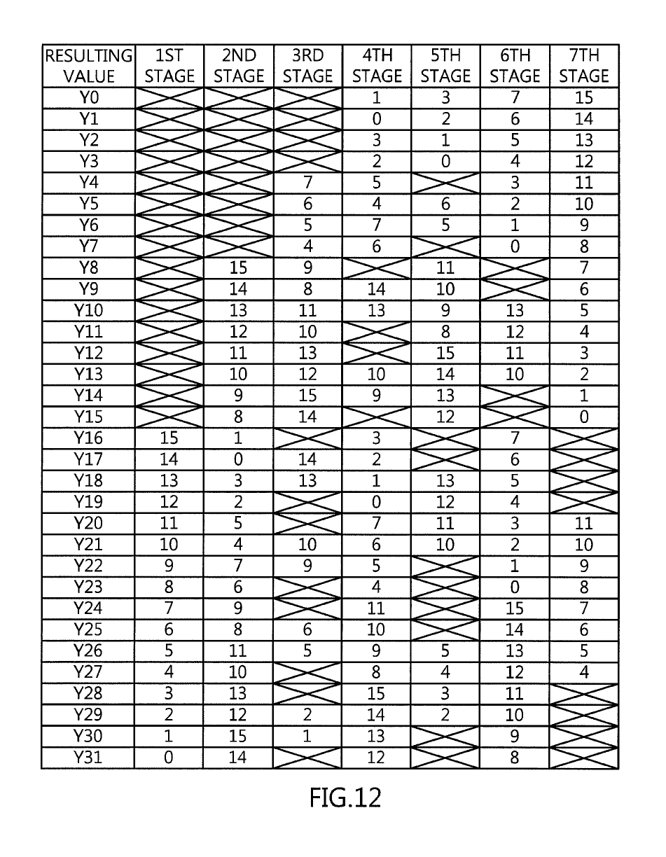

In order to solve this problem, as shown in FIG. 12, which of 31 median values was used has been analyzed for individual stages.

Analysis has been separately performed such that lines Y0 to Y15 on the left side of FIG. 12 are applied to a first group obtained by dividing the 32×32 block size into two groups of a 16×16 block size, and lines Y16 to Y31 on the right side of FIG. 12 are applied to the second of the two groups.

As a result, median values required in all stages in the first line of FIG. 12 are only the 1st, 3rd, 7th, and 15th median values. Similarly, median values required in the second line of FIG. 12 are only the 0th, 2nd, 6th, and 14th median values.

On the 11th line, only the 12th, 10th, 8th, 12th, and 4th median values are required. At this time, since the 12th median value is repeated, only the 4th, 8th, 10th, and 12th median values are consequently required.

That is, it can be seen that each median value needed as input on all the lines is one of four median values.

Therefore, as shown in FIG. 6, a 32:1 multiplexer can be replaced with the 4:1 multiplexer 20.

Accordingly, when the process unit is configured, 16 4:1 multiplexers are used, instead of 16 32:1 multiplexers, thus reducing the area of hardware.

Further, since this method is applied in common to the 16×16 block size, there is no problem even if 16×16 and 32×32 block sizes are processed using a single process element (PE).

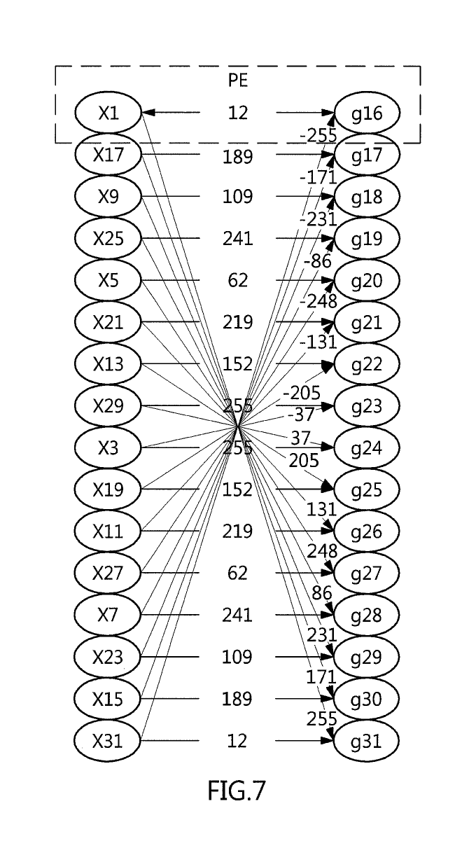

FIG. 7 is a diagram showing the first stage of the inverse transform method for the ultra-high resolution video codec according to an embodiment of the present invention.

Referring to FIG. 7, pixel values classified as an odd-numbered group, among pixel values corresponding to the 32×32 block size, are used as pixel values input to the first stage of the inverse transform method for the ultra-high resolution video codec according to the embodiment of the present invention.

Coefficients are multiplied by respective input pixel values and then median values are obtained by performing an addition operation or a subtraction operation.

For example, in order to obtain a median value g16, an operation of subtracting a value, which is obtained by multiplying 255 by a pixel value X31, from a value, which is obtained by multiplying 12 by a pixel value X1, that is, an operation of g16=12*X1−255*X31, is performed.

As another example, in order to obtain a median value g17, an operation of subtracting a value, which is obtained by multiplying 171 by a pixel value X15, from a value, which is obtained by multiplying 189 by a pixel value X17, that is, an operation of g17=189*X17−171*X15, is performed.

The coefficient values and expressions required to calculate median values g16 to g31 of FIG. 7 can be verified via FIG. 3.

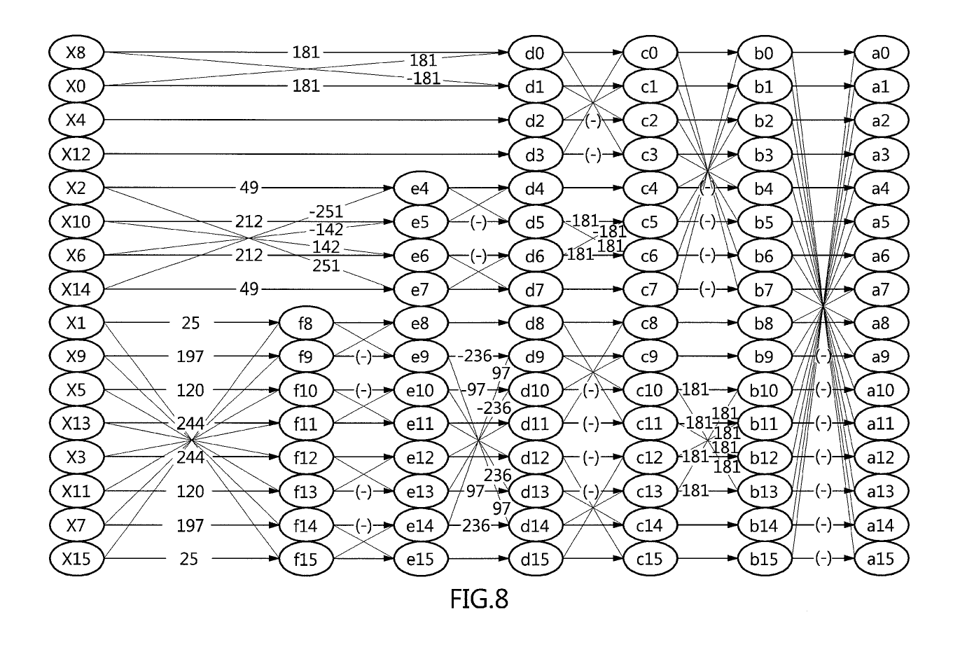

FIG. 8 is a diagram showing an inverse transform method for an ultra-high resolution video codec having a 16×16 block size according to an embodiment of the present invention.

16 input values, that is, X0 to X15, in the leftmost portion of the drawing are inverse-transformed into final values a0 to a15 in the rightmost portion of the drawing through an inverse FDCT algorithm.

As coefficient values applied to individual input values and median values, coefficients of an inverse FDCT algorithm are used, and the order of four optimized input median values can be verified via FIG. 12.

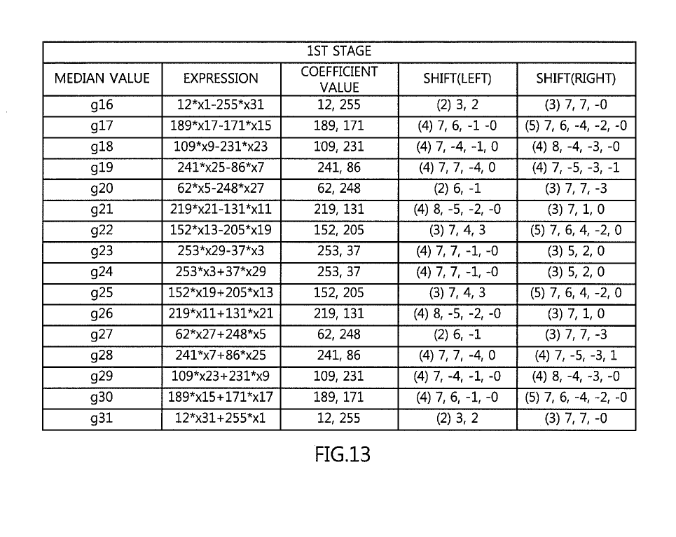

FIG. 9 is a diagram showing a median value calculation procedure according to an embodiment of the present invention, and FIG. 13 is a diagram showing coefficient values and expressions used to calculate median values according to an embodiment of the present invention.

Referring to FIG. 13, in order to obtain a median value g16, an operation of inputting X1 to a pixel value X0 in an upper portion, deriving a value, which is obtained by multiplying 12 by X1, inputting X31 to a pixel value XX in a lower portion, and subtracting from the derived value a value, which is obtained by multiplying 255 by X31, that is, g16=12*x1−255*x31, is performed.

In this case, in order to obtain the median value g16, two multipliers are required.

When this process is implemented using a process unit, a total of 32 multipliers are required, and a problem may arise in that the area of hardware increases.

In order to solve this problem, a multiplication operation is resolved into a shift operation and an addition operation, as shown in FIG. 9, and the median values can be derived without using multipliers.

In order to obtain the median value g16 of FIG. 13, when performing the operation of g16=12*X1−255*X31, 12*X1 can be obtained in such a way as to resolve the coefficient value of 12 into 8 and 4, and add values that are obtained by shifting the input value three times and twice. Similarly, 255*x31 can be obtained in such a way as to resolve the coefficient value of 255 into 128, 128, and −1, to add two values, each being obtained by shifting the input value seven times, and to subtract from an added value a value obtaining by shifting the input value 0 times, thus enabling a multiplication operation to be performed without using the multipliers.

That is, each coefficient value is resolved into numbers corresponding to the nth power of 2, a shifting operation is performed on each of X1 and X31 a number of times corresponding to the exponents of the nth power of 2, and an addition or a subtraction is performed between shifted values of X1 and X31, and thus the median value can be calculated.

Referring to FIG. 13, a value represented by “left” denotes a multiplication operation in the left term of an expression and a value represented by “right” denotes a multiplication operation in the right term of the expression.

In summary, each number indicated in parenthesis denotes the number of shift operators, and each of the remaining numbers denotes the number of times shifting is to be performed.

It can be seen that for a multiplication operation, four or five shift operators are required. Therefore, the upper portion of FIG. 9 illustrates the case where four shift operators 310 and three addition/subtraction operators 320 are required, and the lower portion of FIG. 9 illustrates the case where five shift operators 310 and four addition/subtraction operators 320 are required.

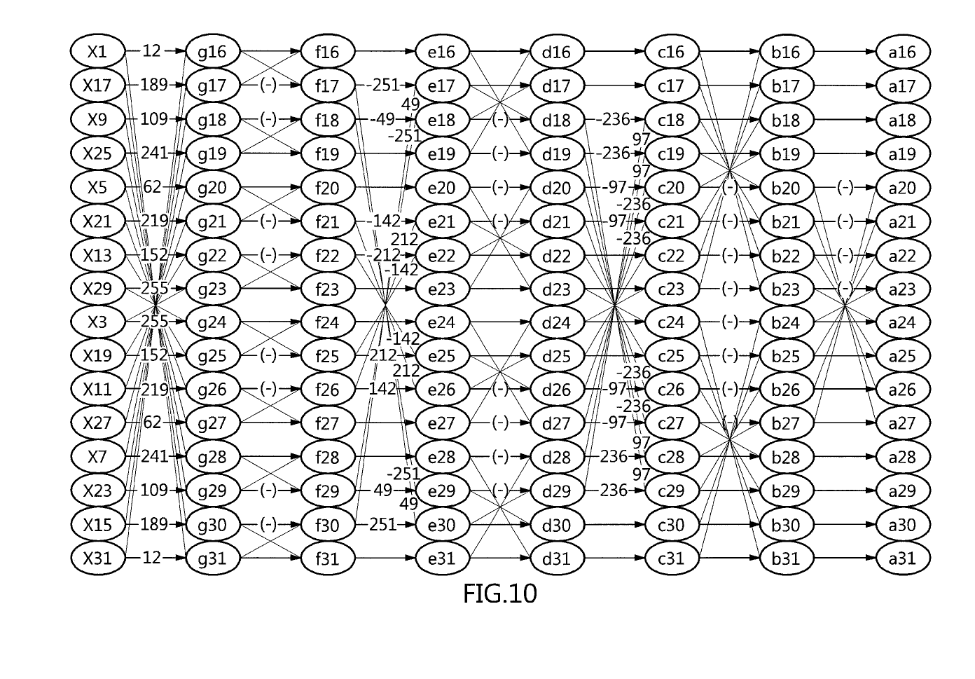

FIG. 10 is a diagram showing an inverse transform method for an ultra-high resolution video codec having a 32×32 block size according to an embodiment of the present invention and FIG. 11 is a diagram showing an inverse transform method for an ultra-high resolution video codec having a 32×32 block size according to an embodiment of the present invention.

As described above, in the case of the 32×32 block size, the corresponding block is divided into two groups of a 16×16 block size and then an operation is performed. Accordingly, if an inverse transform is performed on one 16×16 group, as shown in FIG. 8, and is also performed on the other 16×16 group, as shown in FIG. 10, and the final values a0 to a31 obtained in this way are operated simultaneously, as shown in FIG. 11, pixel values corresponding to the 32×32 block size can be inverse-transformed using only a single process unit capable of inverse-transforming pixel values corresponding to the 16×16 block size.

According to the present invention, transform coding corresponding to two different block sizes can be processed with only a single operation unit by utilizing a common and regular butterfly operation structure upon inverse- transforming pixel values corresponding to 16×16 and 32×32 block sizes.

Further, the present invention can minimize the area of hardware by reusing an optimized operation unit that is designed to minimize the size of multiplexers required for operations and the number of shift operators required for operations.

As described above, the inverse transform method for the ultra-high resolution video codec according to the present invention is not limitedly applied to the configuration and method of the above-described embodiments, and some or all of the embodiments can be selectively combined and configured so that various modifications and changes are possible from the embodiments.

What is claimed is:

1. An inverse transform method for an ultra-high resolution video codec using a Forward Discrete Cosine Transform (FDCT) algorithm, comprising:
inputting one of a plurality of pixel values as a first pixel value;
inputting one of remaining pixel values other than the first pixel value as a second pixel value;
calculating a first median value using a butterfly operation by applying coefficient values, respectively corresponding to the first and second pixel values, to the first and second pixel values; and
replacing the first pixel value with the calculated first median value so as to re-perform the inverse transform method.

2. The inverse transform method of claim 1, wherein the inputting as the second pixel value is configured to select the second pixel value using a 4:1 multiplexer.

3. The inverse transform method of claim 1, wherein the calculating the first median value is configured to resolve each of the coefficient values into numbers corresponding to an nth power of 2, perform a shift operation on each of the first pixel value and the second pixel value a number of times corresponding to exponents of the nth power of 2, and perform addition or subtraction between shifted values of the first and second pixel values, thus calculating the first median value.

4. The inverse transform method of claim 1, wherein the plurality of pixel values are pixel values corresponding to a 16×16 block size.

5. The inverse transform method of claim 1, further comprising:
inputting one of remaining pixel values, other than the first pixel value and the second pixel value among the plurality of pixel values, as a third pixel value;
inputting one of remaining pixel values, other than the first pixel value, the second pixel value, and the third pixel value, as a fourth pixel value;
calculating a second median value using a butterfly operation by applying coefficient values, respectively corresponding to the third and fourth pixel values, to the third and fourth pixel values;
replacing the second pixel value with the second median value so as to re-perform the inverse transform method; and
calculating final value using a butterfly operation by applying coefficient values, respectively corresponding to the first and second median values, to the first and second median values.

6. An inverse transform method for an ultra-high resolution video codec, the method inverse-transforming pixel values corresponding to a 32×32 block size using a Forward Discrete Cosine Transform (FDCT) algorithm, comprising:
dividing the pixel values into a first group and a second group, each having pixel values corresponding to a 16×16 block size;
selectively inputting two pixel values of 16 pixel values of the first group and calculating 16 median values using a butterfly operation; and
selectively inputting two of the 16 median values and calculating 16 final values using the butterfly operation.

7. The inverse transform method of claim 6, further comprising:
selectively inputting two pixel values of 16 pixel values of the second group and calculating 16 median values using a butterfly operation; and
selectively inputting two of the 16 median values and calculating 16 final values using the butterfly operation.

8. The inverse transform method of claim 7, further comprising selectively inputting two final values of 32 final values calculated by the first and second groups, and calculating 32 finally transformed values using the butterfly operation.

9. The inverse transform method of claim 6, wherein the dividing into the first and second groups is configured to divide the pixel values into odd-numbered pixel values and even-numbered pixel values.
